(19) United States
(12) Patent Application Publication
(10) Pub. No.: US 2015/0138169 A1
(43) Pub. Date: May 21, 2015

(54) DISPLAY PANEL, PIXEL STRUCTURE THEREIN AND DRIVING METHOD THEREOF

(71) Applicant: SHENZHEN CHINA STAR OPTOELECTRONICS TECHNOLOGY CO. LTD., Shenzhen, Guangdong (CN)

(72) Inventors: Xiaohui Yao, Shenzhen (CN); Je-Hao Hsu, Shenzhen (CN); Jingfeng Xue, Shenzhen (CN)

(21) Appl. No.: 14/342,297

(22) PCT Filed: Jan. 28, 2014
(86) PCT No.: PCT/CN2014/071662

§ 371 Date: Feb. 28, 2014

(30) Foreign Application Priority Data
Nov. 21, 2013 (CN) 201310594380.1

(51) Int. Cl. G09G 3/36

(52) U.S. Cl. CPC G09G 3/3611; G09G 2320/0261; G09G 2340/16; G09G 2320/0252
USPC 345/204

(57) ABSTRACT

The present disclosure relates to a display panel, a pixel structure therein, and a driving method thereof. The pixel structure includes a plurality of sub pixels, each of them including: a first display area, configured to receive a scan signal of a first scan line and then receive a data signal of a data line so as to have a first potential; a second display area, configured to receive the first potential from the first display area so as to have a second potential; a third display area, configured to receive a scan signal of a second scan line adjacent to the first scan line, and then receive the second potential from the second display area so as to have a third potential; and a capacitor electrically connecting the first display area with the second display area, wherein the first potential of the first display area can be reduced through the capacitor. With the above pixel structure, compatible display for 2D and 3D display modes can be realized when the penetration rate of the 2D display mode is ensured. Moreover, a low color shift effect can be achieved in both 2D and 3D display modes, thus improving the display effect.

### FIELD OF THE INVENTION

The present disclosure relates to a liquid crystal display, and particularly relates to a display panel, a pixel structure therein, and a driving method thereof.

### BACKGROUND OF THE INVENTION

In recent years, with the display becomes thinner and thinner, Liquid Crystal Display (LCDs for short) has been widely used in various electronic products, such as mobile phones, notebook computers, and color televisions.

Vertical Alignment Liquid Crystal Display (VA-LCD for short) is widely used in the existing display products. The VA-LCD is featured by 16.7M color and large visual angle, among others. However, as liquid crystal orientations viewed under different viewing angles are different, distortion of colors viewed under large viewing angles will be generated. Accordingly, when the liquid crystal pixel is designed, a sub-pixel is generally divided into two portions of 8 domains as shown in FIG. 1, in order to eliminate color distortion under large viewing angles. One portion is a Main area, and the other portion is a Sub area. Then, color distortion under large viewing angles can be eliminated by controlling the voltages of both areas, which is referred to as a Low Color Shift (LCS) design.

Three-dimensional (3D) LCD is a novel display trend, and a Film Pattern Retarder (FPR) is one of the mainstream technologies of 3D display mode. This technology can realize a 3D effect through allowing left and right eyes to see different lines of pictures. To avoid a 3D cross-talk phenomenon, the shielding distance between the upper and lower lines of pixels should be designed to be appropriately longer than in the traditional 3D FPR pixel design. However, this design may affect the penetration rate under the condition of two-dimensional (2D) display mode. In addition, in the conventional LCS design the pixel is divided into two areas, namely a Main area and a Sub area, so that the LCS effect can not be realized under 3D display mode. Therefore, in the field it is necessary to solve the above-mentioned problem so as to improve the compatibility between 2D display mode and 3D display mode of the liquid crystal display and the display effect of low color shift.

### SUMMARY OF THE INVENTION

The present disclosure aims to provide a pixel structure of a display panel, which may effectively improve the compatibility between 2D display mode and 3D display mode of a liquid crystal display, and further improve the low color shift display effect of 2D display mode and 3D display mode. In addition, the present disclosure also aims to a display panel including the pixel structure and a driving method for the display panel.

1) To solve the above-mentioned technical problem, the present disclosure provides a pixel structure including a plurality of sub pixels, wherein each sub pixel includes: a first display area, configured to receive a scan signal of a first scan line and then receive a data signal of a data line so as to have a first potential; a second display area, configured to receive the first potential from the first display area so as to have a second potential; a third display area, configured to receive a scan signal of a second scan line adjacent to the first scan line, and then receive the second potential from the second display area so as to have a third potential; and a capacitor electrically connecting the first display area with the second display area, wherein the first potential of the first display area can be reduced through the capacitor.

2) In a preferred embodiment of item 1) of the present disclosure, the first and third display areas each include a switching element, which includes a gate, a first source/drain and a second source/drain,

wherein the gate of the first display area is electrically connected with the first scan line, the first source/drain of the first display area is electrically connected with a first sub pixel electrode of the first display area, and the second source/drain of the first display area is electrically connected with a data line; and

the gate of the third display area is electrically connected with the second scan line adjacent to the first scan line, the first source/drain of the third display area is electrically connected with a third sub pixel electrode of the third display area, and the second source/drain of the third display area is electrically connected with the second sub pixel electrode of the second display area.

3) In a preferred embodiment of item 1) or 2) of the present disclosure, the capacitor is electrically connected with the first sub pixel electrode of the first display area and the second sub pixel electrode of the second display area.

4) According to another aspect of the present disclosure, a display panel is also provided, including: a plurality of data lines; a plurality of scan lines which are staggered with the data lines to form a plurality of sub pixel areas; and a plurality of sub pixels which are configured in the sub pixel areas respectively. Each sub pixel includes: a first display area, configured to receive a scan signal of a first scan line and then receive a data signal of a data line so as to have a first potential; a second display area, configured to receive the first potential from the first display area so as to have a second potential; a third display area, configured to receive a scan signal of a second scan line adjacent to the first scan line, and then receive the second potential from the second display area so as to have a third potential; and a capacitor electrically connecting the first display area with the second display area, wherein the second potential of the second display area can be reduced through the capacitor.

5) In a preferred embodiment of item 4) of the present disclosure, the first and third display area each include a switching element, which includes a gate, a first source/drain and a second source/drain,

wherein the gate of the first display area is electrically connected with the first scan line, the first source/drain of the first display area is electrically connected with a first sub pixel electrode of the first display area, and the second source/drain of the first display area is electrically connected with a data line; and

the gate of the third display area is electrically connected with the second scan line adjacent to the first scan line, the first source/drain of the third display area is electrically connected with a third sub pixel electrode of the third display area, and the second source/drain of the third display area is electrically connected with the second sub pixel electrode of the second display area.

6) In a preferred embodiment of item 4) or 5) of the present disclosure, the capacitor is electrically connected with the first sub pixel electrode of the first display area and the second sub pixel electrode of the second display area.

7) According to a further aspect of the present disclosure, a method for driving a display panel is also provided, wherein the display panel includes a plurality of data lines, a plurality of scan lines and a plurality of sub pixels. The data lines are staggered with the scan lines to form a plurality of sub pixel areas, in each of which a corresponding sub pixel is provided. And each sub pixel includes a first display area, a second display area, a third display area, and a capacitor electrically connecting the first display area with the second display area. The method includes: within a positive half period of a 2D display mode,

at the same moment, transmitting a data signal to the first display area through a data line so that the first display area has a first potential, and pulling down the first potential of the first display area through the capacitor so that the second display area has a second potential, wherein a potential difference exists between the first potential and the second potential; and

at the next moment, pulling down the second potential through the third display area electrically connected with the second display area, so that voltage differences are formed between the second potential and the first potential and between the potential of the third display area and the first potential respectively.

8) In a preferred embodiment of item 7) of the present disclosure, the method further includes: within a negative half period of a 2D display mode,

at the same moment, transmitting a data signal to the first display area through a data line so that the first display area has a first potential, and pulling up the first potential of the first display area through the capacitor so that the second display area has a second potential, wherein a potential difference exists between the first potential and the second potential; and

at the next moment, pulling up the second potential through the third display area electrically connected with the second display area, so that voltage differences are formed between the second potential and the first potential and between the potential of the third display area and the first potential respectively.

9) According to a further aspect of the present disclosure, a method for driving a display panel is also provided, wherein the display panel includes a plurality of data lines, a plurality of scan lines and a plurality of sub pixels. The data lines are staggered with the scan lines to form a plurality of sub pixel areas, in each of which a corresponding sub pixel is provided. And each sub pixel includes a first display area, a second display area, a third display area, and a capacitor electrically connecting the first display area with the second display area. The method includes:

in a 3D display mode, enabling the third display area to form a black area in advance to cut off the potential of the third display area; and

within a positive half period, at the same moment, transmitting a data signal to the first display area through a data line so that the first display area has a first potential, and pulling down the first potential of the first display area through the capacitor so that the second display area has a second potential, wherein a potential difference exists between the first potential and the second potential.

10) In a preferred embodiment of item 9) of the present disclosure, the method further includes: within a negative half period, at the same moment, transmitting a data signal to the first display area through a data line so that the first display area has a first potential, and pulling up the first potential of the first display area through the capacitor so that the second display area has a second potential, wherein a potential difference exists between the first potential and the second potential; and

11) In a preferred embodiment of item 9) or 10) of the present disclosure, the third display area forms a black area through black interpolation.

Compared with the prior art, one or more examples of the present disclosure may have the following advantages. According to the present disclosure, a pixel structure having 3 areas (Main area, Sub area and Share area) and 12 domains is adopted. Therefore, a low color shift effect can be realized during 2D display mode through pulling down the potential of the Sub area by means of the Share area due to the fact that a charging difference exists between the Main area and the Sub area under the influence of the capacitor C_A connected the Main area with the Sub area. In addition, during 3D display mode, the Share area is turned off, so that a relatively wide space required by 3D FPR display can be formed. In this manner, a low color shift effect of 3D display mode can be realized based on the charging difference between the Main area and the Sub area through the capacitor connecting the two areas. In this case, compatible display for 2D and 3D display modes can be realized when the penetration rate of the 2D display mode is ensured. Moreover, in both 2D and 3D display modes, a low color shift effect can be achieved, thus improving the display effect.

Other features and advantages of the present disclosure will be illustrated in the following description, and are partially obvious from the description or understood through implementing the present disclosure. The objectives and other advantages of the present disclosure may be realized and obtained through the structures specified in the description, claims and accompanying drawings.

### BRIEF DESCRIPTION OF THE DRAWINGS

The accompanying drawings, constituting a part of the description, are provided for better understanding the present disclosure, and for interpreting the present disclosure together with the embodiments of the present disclosure, rather than limiting the present disclosure. In the accompanying drawings:

FIG. 1 is a structural schematic diagram of a sub pixel in the prior art;

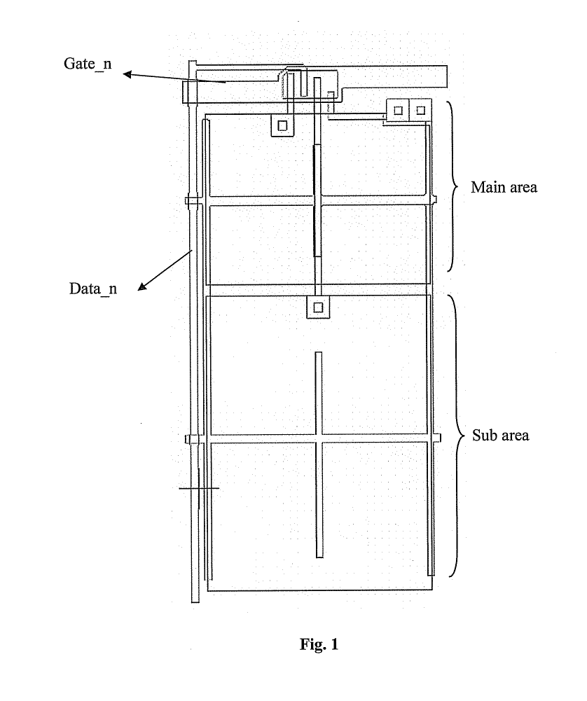

FIG. 2 is a structural schematic diagram of a display panel according to an example of the present disclosure;

FIG. 3 is a structural schematic diagram of a sub pixel according to an example of the present disclosure;

FIG. 4 is a schematic diagram of an equivalent circuit according to the sub pixel shown in FIG. 3;

FIGS. 5 (a) and 5(b) are schematic diagrams of potential variations of sub pixel electrodes in 2D display mode and 3D display mode of the equivalent circuit of the sub pixel shown in FIG. 4 respectively; and

FIG. 6 is a schematic diagram of pixel display when the sub pixel shown in FIG. 3 is in 3D display mode.

### DETAILED DESCRIPTION OF THE EMBODIMENTS

To enable the objectives, technical solutions and advantages of the present disclosure clearer, the present disclosure is further illustrated in detail below in conjunction with the accompanying drawings.

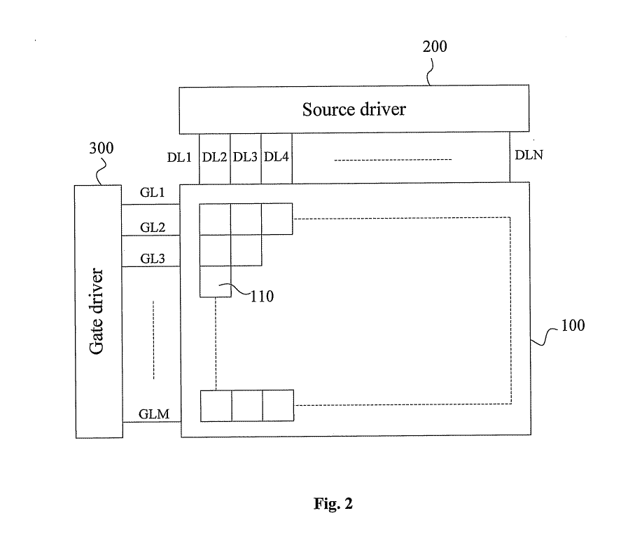

FIG. 2 is a structural schematic diagram of a display panel according to an example of the present disclosure. The display panel includes an image display area 100, a source driver 200, and a gate driver 300. The image display area 100 includes an array formed by staggering a plurality of data lines (e.g., N data lines DL1-DLN as shown in the figure) and a plurality of scan lines (also referred to as gate lines; e.g., M scan lines GL1-GLM as shown in the figure), and a plurality of pixel structures 110. The source driver 200 transmits data signals as provided to the image display area 100 through the plurality of data lines coupled with the source driver 200. The gate driver 300 transmits the scan signals as provided to the image display area 100 through the plurality of scan lines coupled with the gate driver 300.

It should be noted that the term “pixel structure” mentioned here includes a plurality of sub pixels, which are provided in a plurality of sub pixel areas formed by staggering the plurality of data lines and the plurality of scan lines respectively. In this example, the “sub pixels” may be the ones with different colors, such as red (R) sub pixels, green (G) sub pixels or blue (B) sub pixels.

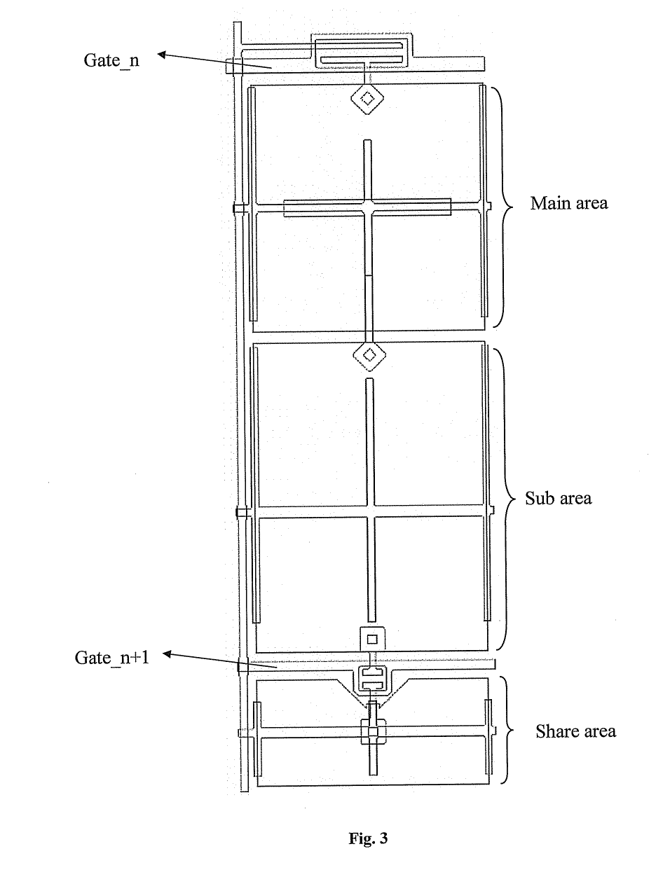

FIG. 3 is a structural schematic diagram of a sub pixel according to an example of the present disclosure. The sub pixel can be used in a display panel shown in FIG. 2. As shown in FIG. 3, the sub pixel includes a first display area (also referred to as Main area), a second display area (also referred to as Sub area) and a third display area (also referred to as Share area). The Main area is configured to receive a scan signal of a first scan line, and then receive a data signal of a data line so as to have a first potential. The Sub area is configured to receive the first potential from the first display area so as to have a second potential. The Share area is configured to receive a scan signal of a second scan line adjacent to the first scan line, and then receive the second potential from the second display area so as to have a third potential.

Each of the above areas includes a plurality of domains respectively. As shown in the figure, each area is divided into four domains, wherein Data_n is configured to send a signal to the Main area to control the Main area, and Gate_n controls the Main area and the Sub area, and Gate_n+1 controls the Share area.

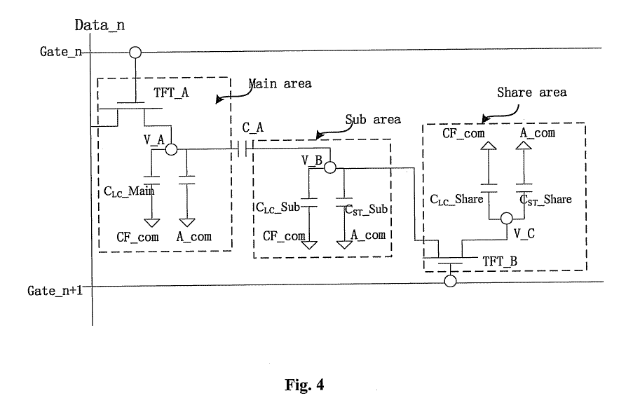

In the following the whole structure of the sub pixel will be illustrated with reference to FIG. 3 and FIG. 4. FIG. 4 is a schematic diagram of an equivalent circuit according to the sub pixel shown in FIG. 3. The sub pixel includes switching elements (TFT_A, TFT_B and TFT_C), a capacitor (C_A), storage capacitors (C_{ST}_{_{—}}Main, C_{ST}_{_{—}}Sub and C_{ST}_{_{—}}Share), and liquid crystal capacitors (C_{LC}_{_{—}}Main, C_{LC}_{_{—}}Sub and C_{LC}_{_{—}}Share). The switching elements TFT_A, TFT_B and TFT_C are preferably made of thin-film transistors.

In addition, CF_Com shown in FIG. 4 indicates a reference potential of an upper substrate of a liquid crystal display, whereas A_com indicates a reference potential of a lower substrate with capacitance. Generally, the two potentials are consistent with each other, and may be collectively referred to as a common electrode VCOM.

For the Main area, the switching element TFT_A is electrically connected between the data line Data_n and a sub pixel electrode V_A, the control end (gate) of the switching element TFT_A is electrically connected with the scan line Gate_n, the storage capacitor C_{ST}_{_{—}}Main is electrically connected between the sub pixel electrode V_A and a common electrode A_com, and the liquid crystal capacitor C_{LC}_{_{—}}Main is electrically connected between the sub pixel electrode V_A and a common electrode CF_com. When the switching element TFT_A is turned on, a data signal of the data line Data_n will be transmitted to the storage capacitor C_{ST}_{_{—}}Main through the switching element TFT_A, and the C_{ST}_{_{—}}Main will be charged to store the corresponding potential according to the data signal. On the basis of which, the sub pixel electrode V_A also has the corresponding potential, and the Main area displays image data accordingly.

For the Share area, the switching element TFT_B is electrically connected between the sub pixel electrode V_B and a sub pixel electrode V_C, the control end of the switching element TFT_C is electrically connected with the scan line Gate_n+1, the storage capacitor C_{ST}_{_{—}}Share is electrically connected between the sub pixel electrode V_C and a common electrode A_com, and the liquid crystal capacitor C_{LC}_{_{—}}Share is electrically connected between the sub pixel electrode V_C and a common electrode CF_com. When the switching element TFT_B is turned on, the potential of the sub pixel electrode V_B will be transmitted to the C_{ST}_{_{—}}Share through the switching element TFT_B, the storage capacitor C_{ST}_{_{—}}Share will store the corresponding potential. Therefore, the sub pixel electrode V_C also has the corresponding potential, and the Share area displays image data accordingly. That is to say, the potential of the sub pixel electrode V_C may pull down the potential of the sub pixel electrode V_B, or the potential of the sub pixel electrode V_C may pull up the potential of the sub pixel electrode V_B.

In addition, the capacitor C_A is electrically connected with the Main area and the Sub area, so as to couple the potentials of the Main area and the Sub area. In this example, the capacitor C_V is electrically connected between the sub pixel electrode V_A of the Main area and the sub pixel electrode V_B of the Sub area. The potential of the sub pixel electrode V_A is divided through the capacitor, and therefore the potential of the sub pixel electrode V_B of the Sub area is equal to the difference between the divided voltages of the sub pixel electrode V_A and the capacitor. The Sub area displays image data accordingly.

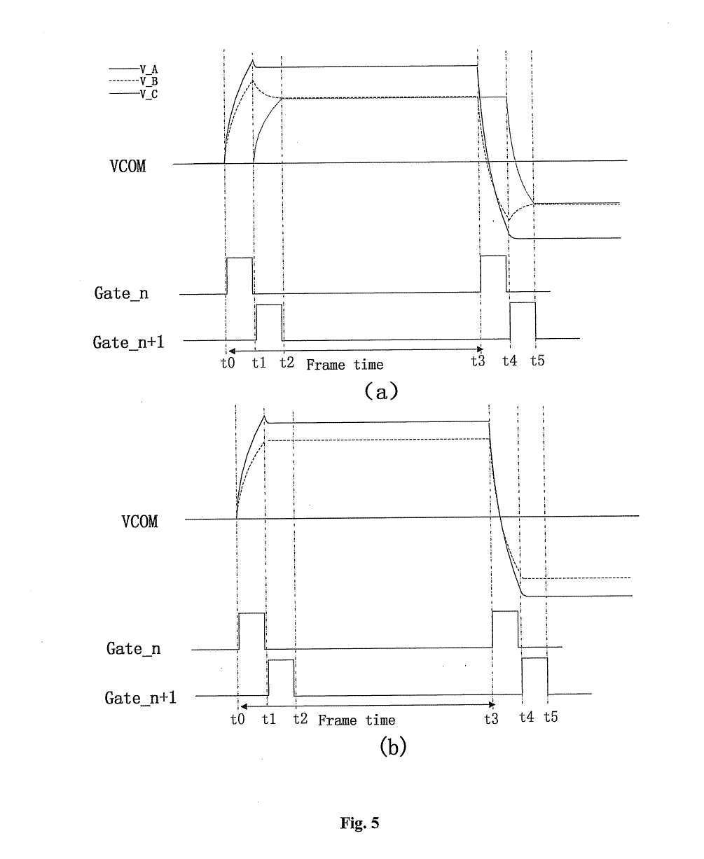

The specific driving condition of each area and the potential variation of each sub pixel point electrode in 2D display mode and 3D display mode will be illustrated below with reference to FIGS. 5(a) and 5(b) respectively. However, FIGS. 5(a) and 5(b) are merely examples, rather than being used for limiting the present disclosure. That is, potential variations of the sub pixel electrodes V_A, V_B and V_C can be adjusted according to actual needs without departing from the spirit and scope of the present disclosure, and the sub pixel electrodes V_A, V_B and V_C shown in FIGS. 5(a) and 5(b) may generally indicate the potential variations of the Main area, the Sub area and the Share area respectively.

In 2D display mode, generally speaking, a certain difference AV is generated between each of the potentials of the Sub area and the Share area and the potential of the Main area by pulling down the potential of the Sub area through the Share area due to the fact that a charging difference exists between the Main area and the Sub area under the influence of the capacitor C_A connecting the Main area with the Sub area. In this manner, a better LCS effect can be achieved.

Specifically, with reference to FIG. 4 and FIG. 5(a), within the positive half period (namely the positive polarity is reversed in polarity reversal, at that time the potential of the data signal is greater than that of the common electrode VCOM), when the scan line Gate_n transmits scan signals (outputs high level) between t0 and t1, the switching element TFT_A will be turned on according to the scan signals, so that the data signal of the data lines Data_n can be transmitted to the storage capacitor C_{ST}_{_{—}}Main through the switching element TFT_A. And the storage capacitor C_{ST}_{_{—}}Main will be charged according to the data signals to store a corresponding potential, so that the sub pixel electrode V_A will have the corresponding potential.

Then, due to the coupling voltage division effect of the capacitor C_A, the sub pixel electrode V_B of the Sub area electrically connected with the capacitor C_A will be charged to store the corresponding potential. It could be easily understood that at this moment, a certain voltage difference ΔV exists between the Sub area and the Main area.

Next, when the scan line Gate_n+1 transmits scan signals (outputs high level) between t1 and t2, the switching element TFT_B will be turned on according to the scan signals, so that the potential of the sub pixel electrode V_B can be transmitted to the storage capacitor C_{ST}_{_{—}}Share through the switching element TFT_B. And the storage capacitor C_{ST}_{_{—}}Share will be charged to store a corresponding potential, so that the sub pixel electrode V_C will have the corresponding potential. At this moment, the voltages of the Share area and the Sub area are consistent with each other, and form the same voltage difference ΔV relative to the Main area.

In comparison, within the negative half period (namely the negative polarity is reversed in polarity reversal, at that time the potential of the data signal is smaller than that of the common electrode VCOM), when the scan line Gate_n transmits scan line signals between t3 and t4, the switching element TFT_A will be turned on according to the scan signals, so that the data signal of the data lines Data_n can be transmitted to the storage capacitor C_{ST}_{_{—}}Main through the switching element TFT_A. And the storage capacitor C_{ST}_{_{—}}Main will be charged according to the data signal to store a corresponding potential, so that the sub pixel electrodes V_A will have the corresponding potential.

Then, due to the coupling voltage division effect of the capacitor C_A, the sub pixel electrode V_B of the Sub area electrically connected with the capacitor C_A will be charged to store the corresponding potential. It could be easily understood that at this moment, a certain voltage difference ΔV exists between the Sub area and the Main area.

Next, when the scan line Gate_n+1 transmits scan signals between t4 and t5, the switching element TFT_B will be turned on according to the scan signals, so that the potential of the sub pixel electrode V_B can be transmitted to the storage capacitor C_{ST}_{_{—}}Share through the switching element TFT_B. And the storage capacitor C_{ST}_{_{—}}Share will be charged to store a corresponding potential, so that the sub pixel electrode V_C will have the corresponding potential. At this moment, the voltages of the Share area and the Sub area are consistent with each other, but form the same voltage difference ΔV with the Main area.

Thus, no matter in the operation of positive polarity reversal or negative polarity reversal, significant potential differences will exist between the Main area and the Sub area and between the Main area and the Share area respectively, in which the potential between the Sub area and the Share area is delayed. Therefore, images displayed in the three areas may be significantly distinguished from one another, thus the problem of color shift of the display in 2D display mode can be effectively solved.

During 3D display mode, generally speaking, at first a black area is formed from the Share area through black interpolation, and then scan signals (Gate signals) of this black area are turned off to keep this area dark. In this manner, a relatively wide space required by 3D FPR display can be formed. The LCS effect of 3D can be finally realized by the charging difference existing between the Main area and the Sub area under the influence of the capacitor C_A.

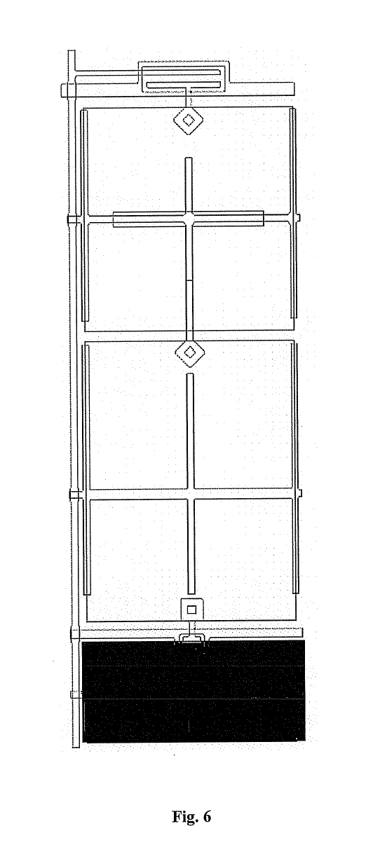

As a black area is formed from the Share area through black interpolation in advance and the scan signals of this black area are turned off, a relatively wide space required by 3D_FPR display is formed, as shown in FIG. 6.

Specifically, with reference to FIG. 4 and FIG. 5(b), within the positive half period (namely the positive polarity is reversed in polarity reversal, at that time the potential of the data signal is greater than the potential of the common electrode VCOM), when the scan line Gate_n transmits scan signals between t0 and t1, the switching element TFT_A will be turned on according to the scan signals, so that the data signal of the data lines Data_n can be transmitted to the storage capacitor C_{ST}_{_{—}}Main through the switching element TFT_A. And the storage capacitors C_{ST}_{_{—}}Main will be charged according to the data signals to store a corresponding potential, so that the sub pixel electrode V_A will have the corresponding potentials.

Then, due to the coupling voltage division effect of the capacitor C_A, the sub pixel electrode V_B of the Sub area electrically connected with the capacitor C_A will be charged to store the corresponding potential. It could be easily understood that at this moment, a certain voltage difference ΔV exists between the Sub area and the Main area.

Then, when the scan line Gate _n+1 transmits the scan signals between time t1 and t2, as the scan signals of the Share area are turned off, the potential of the electrode V_C of this area will be the same as that of the common electrode VCOM, and is regarded as 0.

In comparison, within the negative half period (namely the negative polarity is reversed in polarity reversal, at that time the potential of the data signal is smaller than the potential of the common electrode VCOM), when the scan line Gate_n transmits scan line signals between t3 and t4, the switching element TFT_A will be turned on according to the scan signals, so that the data signal of the data line Data_n can be transmitted to the storage capacitor C_{ST}_{_{—}}Main through the switching element TFT_A. And the storage capacitor C_{ST}_{₁₃} Main will be charged according to the data signals to store a corresponding potential, so that the sub pixel electrode V_A can have the corresponding potential.

Then, due to the coupling voltage division effect of the capacitor C_A, the sub pixel electrode V_B of the Sub area electrically connected with the capacitor C_A will be charged to store the corresponding potential. It could be easily understood that at this moment, a certain voltage difference ΔV exists between the Sub area and the Main area.

Next, when the scan line Gate_n+1 transmits the scan signals between time t4 and t5, as the scan signals of the Share area are turned off, the potential of the electrode V_C of this area will be the same as that of the common electrode VCOM, and is regarded as 0.

Thus, no matter in the operation of positive polarity reversal or negative polarity reversal, a significant potential difference will exist between the Main area and the Sub area. Therefore, images displayed in the two areas may be significantly distinguished from each other, thus the problem of color shift of the display in 3D display mode can be effectively solved.

According to the present disclosure, a pixel structure having 3 areas (Main area, Sub area and Share area) and 12 domains is adopted. Therefore, a low color shift effect can be realized during 2D display mode through pulling down the potential of the Sub area by means of the Share area due to the fact that a charging difference exists between the Main area and the Sub area under the influence of the capacitor C_A connected the Main area with the Sub area. In addition, during 3D display mode, the Share area is turned off, so that a relatively wide space required by 3D FPR display can be formed. In this manner, a low color shift effect of 3D display mode can be realized based on the charging difference between the Main area and the Sub area through the capacitor connecting the two areas. In this case, compatible display for 2D and 3D display modes can be realized when the penetration rate of the 2D display mode is ensured. Moreover, in both 2D and 3D display modes, a low color shift effect can be achieved, thus improving the display effect.

The foregoing descriptions are merely preferred specific embodiments of the present disclosure, but the protection scope of the present disclosure is not limited thereto. Readily conceivable variations or substitutions, to any skilled one who is familiar with this art, within the disclosed technical scope of the present disclosure shall be incorporated in the protection scope of the present disclosure. Accordingly, the protection scope of the claims should be subjected to the protection scope of the present disclosure.

1. A pixel structure including a plurality of sub pixels, each sub pixel including:
a first display area, configured to receive a scan signal of a first scan line and then receive a data signal of a data line so as to have a first potential;
a second display area, configured to receive the first potential from the first display area so as to have a second potential;
a third display area, configured to receive a scan signal of a second scan line adjacent to the first scan line, and then receive the second potential from the second display area so as to have a third potential; and
a capacitor electrically connecting the first display area with the second display area,
wherein the first potential of the first display area can be reduced through the capacitor.

2. The pixel structure according to claim 1, wherein the first and third display areas each include a switching element, which includes a gate, a first source/drain and a second source/drain,
wherein the gate of the first display area is electrically connected with the first scan line, the first source/drain of the first display area is electrically connected with a first sub pixel electrode of the first display area, and the second source/drain of the first display area is electrically connected with a data line; and
the gate of the third display area is electrically connected with the second scan line adjacent to the first scan line, the first source/drain of the third display area is electrically connected with a third sub pixel electrode of the third display area, and the second source/drain of the third display area is electrically connected with the second sub pixel electrode of the second display area.

3. The pixel structure according to claim 2, wherein the capacitor is electrically connected with the first sub pixel electrode of the first display area and the second sub pixel electrode of the second display area.

4. A display panel, including:
a plurality of data lines;
a plurality of scan lines which are staggered with the data lines to form a plurality of sub pixel areas; and
a plurality of sub pixels which are configured in the sub pixel areas respectively, each of the sub pixels including:
a first display area, configured to receive a scan signal of a first scan line and then receive a data signal of a data line so as to have a first potential;
a second display area, configured to receive the first potential from the first display area so as to have a second potential;
a third display area, configured to receive a scan signal of a second scan line adjacent to the first scan line, and then receive the second potential from the second display area so as to have a third potential; and
a capacitor electrically connecting the first display area with the second display area,
wherein the second potential of the second display area can be reduced through the capacitor.

5. The display panel according to claim 4, wherein the first and third display area each include a switching element, which includes a gate, a first source/drain and a second source/drain,
wherein the gate of the first display area is electrically connected with the first scan line, the first source/drain of the first display area is electrically connected with a first sub pixel electrode of the first display area, and the second source/drain of the first display area is electrically connected with a data line; and
the gate of the third display area is electrically connected with the second scan line adjacent to the first scan line, the first source/drain of the third display area is electrically connected with a third sub pixel electrode of the third display area, and the second source/drain of the third display area is electrically connected with the second sub pixel electrode of the second display area.

6. The display panel according to claim 5, wherein the capacitor is electrically connected with the first sub pixel electrode of the first display area and the second sub pixel electrode of the second display area.

7. A method for driving a display panel,
the display panel including a plurality of data lines, a plurality of scan lines and a plurality of sub pixels, wherein the data lines are staggered with the scan lines to form a plurality of sub pixel areas, in each of which a corresponding sub pixel is provided, and each sub pixel includes a first display area, a second display area, a third display area, and a capacitor electrically connecting the first display area with the second display area,
the method including: within a positive half period of a 2D display mode,
at the same moment, transmitting a data signal to the first display area through a data line so that the first display area has a first potential, and pulling down the first potential of the first display area through the capacitor so that the second display area has a second potential, wherein a potential difference exists between the first potential and the second potential; and
at the next moment, pulling down the second potential through the third display area electrically connected with the second display area, so that voltage differences are formed between the second potential and the first potential and between the potential of the third display area and the first potential respectively.

8. The method according to claim 7, wherein further including: within a negative half period of a 2D display mode,
at the same moment, transmitting a data signal to the first display area through a data line so that the first display area has a first potential, and pulling up the first potential of the first display area through the capacitor so that the second display area has a second potential, wherein a potential difference exists between the first potential and the second potential; and
at the next moment, pulling up the second potential through the third display area electrically connected with the second display area, so that voltage differences are formed between the second potential and the first potential and between the potential of the third display area and the first potential respectively.

9. The method according to claim 8, wherein
in a 3D display mode, enabling the third display area to form a black area in advance to cut off the potential of the third display area; and
within a positive half period, at the same moment, transmitting a data signal to the first display area through a data line so that the first display area has a first potential, and pulling down the first potential of the first display area through the capacitor so that the second display area has a second potential, wherein a potential difference exists between the first potential and the second potential.

10. The method according to claim 9, wherein further including: within a negative half period, at the same moment, transmitting a data signal to the first display area through a data line so that the first display area has a first potential, and pulling up the first potential of the first display area through the capacitor so that the second display area has a second potential, wherein a potential difference exists between the first potential and the second potential; and

11. The method according to claim 9, wherein the third display area forms a black area through black interpolation.
